(19) United States
(12) Patent Application Publication
(10) Pub. No.: US 2026/0316413 A1
(43) Pub. Date: Oct. 15, 2026

(54) 3D PRINTING METHODS AND LIGHT GUIDES MADE THEREFROM

(71) Applicant: KDH ADVANCED RESEARCH PTY LTD, Balwyn North, Victoria (AU)

(72) Inventors: Ranjith RAJASEKHARAN UNNITHAN, Balwyn North, Victoria (AU); Younger Wei-Young LIANG, Balwyn North, Victoria (AU); Dechuan SUN, Balwyn North, Victoria (AU); Gregory TANYI, Balwyn North, Victoria (AU)

(21) Appl. No.: 19/483,095

(22) PCT Filed: May 10, 2024
(86) PCT No.: PCT/AU2024/050464

§ 371 Date: Nov. 10, 2025

(30) Foreign Application Priority Data
May 10, 2023 (AU) 2023901422

(51) Int. Cl. B29D 11/00; B29C 64/129; B29K 33/00; B29L 11/00; B33Y 10/00; B33Y 70/10; B33Y 80/00

(52) U.S. Cl. CPC B29D 11/00682; B29C 64/129; B29K 2033/08; B29L 2011/0075; B33Y 10/00; B33Y 70/10; B33Y 80/00

(57) ABSTRACT

This disclosure concerns methods of 3D printing a light guide optical element, comprising 3D printing a base structure using at least one ultra-transparent liquid resin, the base structure comprising a first surface and at least one holding means formed at a second surface opposite to the first surface and angled relative to the first surface; contacting at least one semitransparent beam splitter to the at least one holding means; contacting the at least one ultra-transparent liquid resin over the at least one semitransparent beam splitter and curing the at least one ultra-transparent liquid resin in order to form the light guide optical element. The disclosure also concerns the light guide optical elements therefrom.

### TECHNICAL FIELD

The present invention relates, in general terms, to 3D printing methods and light guide optical elements made therefrom.

### BACKGROUND

A light guide optical element (LOE) is an optical waveguide that guides electromagnetic waves in the optical spectrum from a source to the eyes of a user. The LOE may be used for augmented reality display.

Augmented reality (AR) display technology enables users to perceive a virtual image overlaid onto the real world AR integrates and overlays virtual information onto the user's physical world in real-time. Optical see-through near-eye displays are frequently utilized in AR display systems, where light guide optical elements (LOEs) are generally employed to direct the light emanating from the display panel towards the user's eye.

Based on the disclosed business plans of leading technology companies within the augmented reality (AR) domain, AR has a vast potential market and is likely to become the next generation computing platform. This may lead consumers to transition away from traditional mobile devices. In contrast to conventional smart glasses, which merely overlay content onto a head-mounted display, AR enables more vivid interactions for viewers with virtual information, without affecting the viewer's natural vision. Up to now, AR has been gradually utilized in navigation, entertainment, healthcare, manufacturing, education, and military. With a diverse range of applications in industry, driving, and education, AR has the potential to become the next-generation computing platform.

One of the key components in near-eye displays for AR applications is an optical waveguide or combiner. The commercially available optical combiners can be broadly categorized into two major types based on their working principle: geometric and diffractive. The geometric waveguide structure was first proposed by Lumus and has undergone continuous optimization over the past twenty years. In this approach, incident light first enters the waveguide through a reflective surface. After undergoing multiple rounds of total internal reflection, the light encounters a “semi-transmissive semi-reflective” mirror array, which couples the light out. On the other hand, the diffractive waveguide structure utilizes diffractive optical elements such as surface relief gratings or volume holographic gratings to couple the light into and out of the waveguide. Similar to the geometric waveguide structure, the use of surface relief gratings also provides an effective approach. This involves introducing an incident grating to couple light into the waveguide and substituting the mirror array with an exit grating. Companies such as Microsoft, Vuzix, Magic Leap, and Waveoptics have commercialized devices using this technique. Another diffractive waveguide structure is based on the utilization of volume holographic gratings, employing a different grating fabrication technique closely related to hologram production. While products based on this technology are currently limited in the market, prototypes showcasing the potential of this approach have been demonstrated by Digilens and Sony. A summary of these AR glasses is shown in Table 1.

TABLE 1
AR glasses available on the market. Due to the
challenges in manufacturing AR waveguides,
most AR glasses require a long lead time.

| Waveguide | Company | Cost |
|---|---|---|
| Geometric | Lumus | $3000 |
| Surface relief | Microsoft Hololens 2 | $3500 |
| gratings | Vuzix M4000 | $2500 |
| | Magic Leap 2 | $3299 |
| | Waveoptics Katana | Currently not available |
| Volume holographic | Digilens | Currently not available |
| gratings | Sony | Currently not available |

In addition to these approaches, numerous alternative optical waveguides using different methodologies are reported in the literature, such as using holographic optical elements, pinlight configurations, meta surfaces, and polarization devices. However, these technologies have not yet been commercialized due to various challenges in the fabrication process.

Both geometric and diffractive waveguides exhibit advantages and disadvantages. Diffractive waveguide technology relies on the deposition of a thin film on glass substrates, eliminating the need for glass slicing and bonding processes used in fabricating geometric waveguides. This provides advantages in terms of flexibility in design and production. However, a notable drawback is the presence of chromatic aberration or the appearance of the rainbow effect. Moreover, diffractive waveguides may have limitations in their field of view. These issues primarily stem from the inherent selectivity of diffraction gratings with respect to light input angles and wavelengths. Additionally, the refractive index of the waveguide also plays a role in these limitations. In contrast, the geometric waveguide structure can offer a large field of view, excellent image quality, and no colour dispersion. However, the commercialization of both methodologies faces challenges due to limitations in mass production capabilities. Consequently, most AR glasses on the market are expensive.

Traditional manufacturing methods for LOEs are costly, time-intensive, not possible to make curved or any other shape and often result in poor image quality. There currently exist two principal approaches for the fabrication of LOEs. The first method entails the deposition of numerous layers of materials exhibiting varying refractive indices onto a glass surface via techniques such as photolithography, physical vapor deposition, and electron-beam evaporation, then go through a layer-by-layer lamination, cutting, and further optical or air bonding process to make. The second method traditionally depends on injection molding or hot embossing, which are difficult for mass production due to their time-intensive and costly nature. In addition, these fabrication techniques are prone to insufficiencies in precision and uniformity across any microstructure used, which may result in the deterioration of the displayed image quality.

It would be desirable to overcome or ameliorate at least one of the above-described problems. It would be desirable to overcome or ameliorate manufacturing challenges owing to the high optical performance requirements, miniaturization and lightweight constraints. It would be desirable to overcome or ameliorate the insufficient production capability for their mass production.

### SUMMARY

The present disclosure provides a method of 3D printing a light guide optical element, comprising:
a) 3D printing a base structure using at least one ultra-transparent liquid resin, the base structure comprising a first surface and at least one holding means formed at a second surface opposite to the first surface and angled relative to the first surface;
b) contacting at least one semitransparent beam splitter to the at least one holding means; and
c) contacting the at least one ultra-transparent liquid resin over the at least one semitransparent beam splitter and curing the at least one ultra-transparent liquid resin in order to form the light guide optical element.

In some embodiments, the base structure is 3D printed on a substrate.

In some embodiments, step a) comprises depositing and at least partially curing the at least one ultra-transparent liquid resin in a slice-by-slice manner. By 3D printing the base structure, the formation of air pockets during the curing process is precluded.

In some embodiments, the base structure is 3D printed using liquid crystal display (LCD) 3D printing.

In some embodiments, step a) comprises varying a refractive index of the at least one ultra-transparent liquid resin such that at least one 3D printed slice of the base structure has a different refractive index relative to an adjacent 3D printed slice. This allows for light path compensation in cases where the total internal reflected light path is shifted by curvature or thickness changes induced by, for example, bending the light guide optical element.

In some embodiments, step a) comprises at least partially curing the at least one 3D printed slice of the base structure under different conditions relative to the adjacent 3D printed slice.

In some embodiments, the at least one 3D printed slice is at least partially cured under a pattern of light which is different relative to the adjacent 3D printed slice.

In some embodiments, the at least one 3D printed slice is at least partially cured under a light intensity which is different relative to the adjacent 3D printed slice.

In some embodiments, step a) comprises 3D printing the base structure using a second ultra-transparent liquid resin having a different refractive index such that at least one 3D printed slice of the base structure has a different refractive index relative to an adjacent 3D printed slice.

In some embodiments, step a) comprises 3D printing the base structure using a mixture of the at least one ultra-transparent liquid resin and a second ultra-transparent liquid resin having a different refractive index such that at least one 3D printed slice of the base structure has a different refractive index relative to an adjacent 3D printed slice.

In some embodiments, step a) comprises:
i) 3D printing a slice of the base structure;
ii) mixing a portion of a second ultra-transparent liquid resin to the at least one ultra-transparent liquid resin;
iii) 3D printing a subsequent slice of the base structure; and
iv) iteratively repeating step ii) and iii) until the base structure is formed.

In some embodiments, the difference in refractive index between the 3D printed slices is about 0.001 to about 0.1.

In some embodiments, the ultra-transparent liquid resin is a UV curable resin.

In some embodiments, the ultra-transparent liquid resin is an acrylic based resin.

In some embodiments, step a) is performed at an ambient temperature, or preferably at about 20° C. to about 40° C.

In some embodiments, the ultra-transparent liquid resin is characterised by a viscosity of about 400 MPa to about 700 MPa, or preferably about 450 MPa to about 600 MPa.

In some embodiments, the ultra-transparent liquid resin is characterised by a volume shrinkage of less than 8%, or preferably less than 1%.

In some embodiments, the 3D printing is further performed in the presence of a release liner and/or a hydrophobic material.

In some embodiments, the at least one holding means is a slope cut into the second surface of the base structure.

In some embodiments, the at least one holding means is angled at about 20° to about 40°.

In some embodiments, the at least one holding means is 3 holding means, and the at least one semitransparent beam splitter is 3 semitransparent beam splitters.

In some embodiments, the at least one semitransparent beam splitter is selected from a dielectric reflector, metal reflector or a combination thereof.

In some embodiments, the at least one semitransparent beam splitter is characterised by a transparency of at least 85%.

In some embodiments, the at least one semitransparent beam splitter is characterised by a reflection ratio of about 8% to about 20%, or preferably about 10%.

In some embodiments, the semitransparent beam splitter is characterised by root mean square (RMS) roughness of about 1.1 nm to about 1.8 nm.

In some embodiments, step c) comprises immersing the 3D printed base structure in a tank comprising ultra-transparent liquid resin, and immersing the at least one semitransparent beam splitter in the tank comprising ultra-transparent liquid resin such that the at least one semitransparent beam splitter contacts the holding means of the base structure.

In some embodiments, the method further comprises a step of separately 3D printing a top structure, the top structure comprises a third surface and a fourth surface opposite the third surface, wherein the fourth surface comprises a complementary morphology relative to second surface of the base structure and the at least one semitransparent beam splitter.

In some embodiments, the method further comprises a step of mating the base structure and the at least one semitransparent beam splitter with the top structure to form the light guide optical element.

In some embodiments, the base structure and the at least one semitransparent beam splitter are mated and cured with the top structure in the tank comprising ultra-transparent liquid resin.

In some embodiments, step c) comprises contacting a transparent substrate and the at least one ultra-transparent liquid resin over the holding means and the second surface of the base structure to form a covered recess, curing the at least one ultra-transparent liquid resin such that the transparent substrate is adhered to the second surface, and filling the covered recess with a transparent liquid to form the light guide optical element.

In some embodiments, the transparent liquid is characterised by a refractive index of about 1.4 to about 1.8.

In some embodiments, the transparent liquid is silicone oil, mineral oil, polydimethylsiloxane (PDMS), or a combination thereof.

In some embodiments, step c) comprises 3D printing the ultra-transparent liquid resin over the at least one semitransparent beam splitter. In some embodiments, step c) comprises depositing and at least partially curing the ultra-transparent liquid resin in a slice-by-slice manner. In this way, any gap or space adjacent to the at least one semitransparent beam splitter may be filled up in a layer-by-layer manner.

In some embodiments, step c) comprises varying a refractive index of the ultra-transparent liquid resin such that at least one 3D printed slice has a different refractive index relative to an adjacent 3D printed slice.

In some embodiments, the base structure further comprises a prism structure at an end thereof.

In some embodiments, the prism is a triangular prism positioned at an angle of about 40° to about 60° relative to the first surface of the base structure.

In some embodiments, the method further comprises a step after step a) of cleaning and further curing the base structure of step a).

In some embodiments, the method further comprises varying a refractive index of the light guide optical element such that at least one 3D printed slice of the light guide optical element has a different refractive index relative to an adjacent 3D printed slice.

In some embodiments, the method further comprises thermal annealing the light guide optical element.

In some embodiments, the light guide optical element is characterised by a transparency of more than about 85%.

The present disclosure also provides a 3D printed light guide optical element formed by the method as disclosed herein.

The present disclosure also provides 3D printed light guide optical element, comprising:
a) an ultra-transparent body having a first surface; and
b) at least one semitransparent beam splitter within the ultra-transparent body and angled relative to the first surface;
wherein the 3D printed light guide optical element is characterised by at least one 3D printed slice having a different refractive index relative to an adjacent 3D printed slice.

The present disclosure also provides 3D printed light guide optical element, comprising:
a) an ultra-transparent body having a first surface; and
b) at least one semitransparent beam splitter within the ultra-transparent body and angled relative to the first surface;
wherein a cross section of the 3D printed light guide optical element is characterised by a portion of the cross section having a different refractive index relative to another portion.

### BRIEF DESCRIPTION OF THE DRAWINGS

Embodiments of the present invention will now be described, by way of non-limiting example, with reference to the drawings in which:

FIG. 1. (Left) 2D Schematics of waveguide showing reflector orientation, image formation direction and direction of light coupling. (Right) 3-Dimensional representation of a waveguide.

FIG. 2. Ray trace showing light path, image combination and pupil expansion as light propagates from coupling optics to the end user eye.

FIG. 3. (Left) Object (bitmap file) loaded into model such that the spatial density of rays released from the object surface is proportional to the value of the imported bitmap. (Right) Reconstructed image at the Image plane using 23000 rays showing magnified, perfectly stitched image (rotated for ease of view).

FIG. 4. 3D printed base of the light guide optical element.

FIG. 5. A 3D printed AR waveguide display prototype and see through image displayed. The image was coupled from a LCOS based light engine. A camera was used to capture the floating image.

FIG. 6. A side view of the light guide optical element with layers of different refractive index to compensate total internal refraction (TIR) imaging shift in case of curved waveguide.

FIG. 7. Ray trace showing light path, image combination, and pupil expansion as light propagates from coupling optics to the user's eye. The object (bitmap file) is loaded into the model in such a way that the spatial density of rays released from the object surface is proportional to the values in the imported bitmap. The reconstructed image at the image plane, generated using 23,000 rays, displays a magnified, perfectly stitched, and flipped image. A 2D schematic of the waveguide illustrates the critical angles and dimensions of the combiner.

FIG. 8. The adapted printing platform and the fabrication process. Schematics illustrate the modified 3D printing platform. To enhance light distribution uniformity, a diffuser and an absorber were placed in front of the light source. Additionally, another diffuser was positioned on top of the LCD screen. The top and bottom components of the waveguide were printed separately on glass printing beds and later integrated with the dielectric reflectors.

FIG. 9. Illumination uniformity and LCD inter-pixel gap issues. (Left) A comparative example showing the illumination uniformity with and without the use of the light source diffuser. As the intensity of the light source is too strong, saturating the camera sensor, an optical filter is employed to reduce the LED intensity, revealing illumination patterns depicted in the bottom right subfigures. (Right) Without the LCD diffuser, the printed sample displayed numerous fine lines within the body, as indicated by the arrows. However, these lines disappeared after the diffuser was applied. To enhance line visibility, the transparent sample was placed on a piece of black paper and observed under a microscope.

FIG. 10. Surface roughness and transmittance ratio of the reflector and the 3D printed sample with a thickness of 3 mm. (Left) The 2D surface roughness maps of the reflector and a printed resin block were measured over a small area (5 μm×2.5 μm). (Right) The transmittance ratio of the reflector was measured at an incident angle of 0-degree and 65-degree. The transmittance ratio of the 3D printed resin block was measured at an incident angle of 0-degree, showing an average transmittance ratio of 92.3% above 420 nm.

FIG. 11. Experimental results. (a) A prototype of the printed waveguide that integrates three reflectors. (b) A prototype is placed at an angle to show the reflectors. (c) The projected image. (d) The overlap of the virtual image with the real world. The virtual image is horizontally mirrored due to the combiner design.

FIG. 12. (a) The design of an optical system. (b) The left figure shows the objective bitmap image and the right figure demonstrates the stitched reconstructed image at the retina. (c) An illustration of the fabrication process.

FIG. 13. (a) A prototype of the liquid optical combiner. (b) An example of the virtual image captured through the liquid optical combiner, which overlaps with the lab environment. The projected source image is shown in the bottom-left corner.

### DETAILED DESCRIPTION

The present disclosure is predicated on the understanding that mass production of augmented reality (AR) waveguides has been challenging due to the intricate nature of the fabrication technique and the high precision required for its optical characteristics.

Without wanting to be bound by theory, the inventors believe that ultra transparent liquid resin may be used in 3D printing technology to additively or synergistically to solve the above mentioned problems, by facilitating the production of 3D-printed optics that exhibit a quality comparable to that of traditional optical components. This specialized resin is formulated to minimize cloudiness and demonstrate low shrinkage after UV light curing, thereby enabling the fabrication of AR optical combiners that offer exceptional clarity and transparency. Additive manufacturing (or 3D printing) involves the successive layer-by-layer deposition of material to generate a three-dimensional object. This approach facilitates the production of complex and customized geometries that may pose difficulties when utilizing traditional manufacturing techniques. Moreover, 3D printing allows for streamlined mass production and decreased production expenses. Accordingly, a 3d printing method suitable for making optical quality AR displays is disclosed herein.

Herein, a low-cost approach is presented for fabricating geometric light guide optical element (or waveguide) designed for AR applications utilizing 3D printing techniques. To strike a balance between optical performance and fabrication feasibility, the conventional geometric waveguide design was optimised to facilitate easier fabrication. The waveguide integrates at least three dielectric reflectors. The method does not require molding, dicing, and post-surface polishing after printing. The waveguide has a manufacturing cost of about $5. A prototype based on this method has been successfully fabricated, showing the immersion between the virtual image and the real-world scene. The method has great potential for adaptation to mass production in various AR applications.

Accordingly, the present disclosure relates to a method of 3D printing a light guide optical element, comprising:
a) 3D printing a base structure using at least one ultra-transparent liquid resin, the base structure comprising a first surface and at least one holding means formed at a second surface opposite to the first surface and angled relative to the first surface;
b) contacting at least one semitransparent beam splitter to the at least one holding means; and
c) contacting the at least one ultra-transparent liquid resin over the at least one semitransparent beam splitter and curing the at least one ultra-transparent liquid resin in order to form the light guide optical element.

The present disclosure relates to a 3D printing technique to make light guide optical element (LOE) for augmented reality display. The disclosure enables efficient mass production and is particularly useful in near-eye displays. The LOE is designed to manipulate the direction and intensity of the light.

3D printing or additive manufacturing is the construction of a three-dimensional object from a CAD model or a digital 3D model. It can be done in a variety of processes in which material is deposited, joined or solidified under computer control, with material being added together (such as plastics, liquids or powder grains being fused), typically layer by layer.

In 3D printing, Stereolithography (SLA) and Digital Light Processing (DLP) may be used for resin printing. Both technologies rely on the controlled emission of UV radiation on a vat of liquid resin, turning into a solid polymer according to a pre-defined model loaded into the slicer software. In SLA, a laser at the UV frequency is directed towards the vat of liquid resin. The point of emission is controlled by a mirror galvanometer. The laser moves along a single layer of the resin spot by spot until the layer is completed, after which the build platform moves to allow for the fresh resin to be exposed to UV radiation. In DLP, the process is similar except that UV radiation is projected on an entire layer at a time using an array of micrometer-sized mirrors, each of which can rotate to control the point of emission of UV radiation. A panel of LED lights may also be used. For both SLA and DLP printers, printing can be done at either the bottom-up or top-down orientations. The major difference between the two is the location of the light source.

In some embodiments, the 3D printing is resin based 3D printing. This is an additive manufacturing method that cure liquid photopolymers layer-by-layer into a solid object. For example, the 3D printing may be stereolithography (SLA) 3D printing. A printing bed or platform may be immersed in a transparent resin vat and exposed to UV light emitted by an array of LEDs from the bottom or from the top. A UV screen may be used to mask UV light so as to be able to print an appropriate 3D structure. The screen may provide a pixel resolution of about 22 μm, and the dual linear rails offer a stable z-axis step size of 10 μm.

The 3D printing process for the light guide optical element (LOE) may involve first designing the base structure using computer-aided design (CAD) software, as shown in FIG. 4. Other software may be used. The base structure is thus printed following a template in a slice-by-slice manner. The template may be designed to incorporate at least one holding means. By altering the template and hence the base structure to be printed, the light guide optical element may be configured for different augmented reality displays.

The base structure may be printed using a liquid crystal display (LCD) 3D printer. A LCD 3D printer is configured to provide a LCD screen which is generated based on a layer of a model of the 3D structure to be printed. UV light may transmit through the LCD screen which cures the resin. In this way, an entire layer may be irradiated at once with UV light. This means that 3D printing with a 3D LCD printer may be faster and more precise than with other 3D printers.

The LCD 3D printer differs from other types of 3D printers, such as DLP or SLA printers, in its light source. LCD 3D printers use a UV LCD array as a light source. As a result, the light from the LCD flat panels shines directly, in a parallel fashion, onto the work area. Since this light is not expanded, pixel distortion is much less of a problem with LCD printing.

The at least one ultra-transparent liquid resin may be poured into the 3D printer slowly so as not to generate air bubbles.

In some embodiments, the base structure is 3D printed on a substrate. The substrate may have a smooth surface, such as glass. To further improve the smoothness of the surface, and hence the smoothness of the resultant 3D printed product, the surface of the substrate may be polished or etched with ozone water. The substrate may be temporarily held to the printing bed by an adhesive such as glue or double sided tape.

In some embodiments, step a) comprises depositing and at least partially curing the at least one ultra-transparent liquid resin in a slice-by-slice manner. By 3D printing the base structure, the formation of air pockets during the curing process is precluded.

In some embodiments, step a) comprises varying a refractive index of the at least one ultra-transparent liquid resin such that at least one 3D printed slice of the base structure has a different refractive index relative to an adjacent 3D printed slice. This allows for light path compensation in cases where the total internal reflected light path is shifted by curvature or thickness changes induced by, for example, bending the light guide optical element. Certain regions of the light guide optical element may also be made thicker for additional structural support. However a difference in thickness may cause the light path in the light guide optical element to stray and diverge, thus producing a blurred virtual image to the user. This may be compensated by varying the refractive index at certain regions within the light guide optical element.

In some embodiments, step a) comprises varying a curing duration of the ultra-transparent liquid resin such that at least one 3D printed slice of the base structure has a different refractive index relative to an adjacent 3D printed slice.

In some embodiments, step a) comprises at least partially curing (or polymerising) the at least one 3D printed slice of the base structure under different conditions relative to the adjacent 3D printed slice.

In some embodiments, the at least one 3D printed slice is at least partially cured under a pattern of light which is different relative to the adjacent 3D printed slice. In some embodiments, the at least one 3D printed slice is at least partially cured under a light intensity which is different relative to the adjacent 3D printed slice. The intensity of the light may be adjusted within the range 0-3 W/cm². Thus, for example, one 3D printed slice may be cured using light of about 2.1 W/cm², while an adjacent slice may be cured using light of about 2.2 W/cm².

In some embodiments, step a) comprises 3D printing the base structure using a second ultra-transparent liquid resin having a different refractive index such that at least one 3D printed slice of the base structure has a different refractive index relative to an adjacent 3D printed slice. In this regard, a 3D printed slice may be formed using the at least one ultra-transparent liquid resin and an adjacent slice may be formed using the second ultra-transparent liquid resin.

In some embodiments, step a) comprises 3D printing the base structure using a mixture of the at least one ultra-transparent liquid resin and a second ultra-transparent liquid resin having a different refractive index such that at least one 3D printed slice of the base structure has a different refractive index relative to an adjacent 3D printed slice. In this regard, the refractive index of the resultant 3D slice is varied by a ratio of the at least one ultra-transparent liquid resin and the second ultra-transparent liquid resin. By having 3D slices with different ratios, the refractive index may be varied or gradiented.

In some embodiments, step a) comprises:
i) 3D printing a slice of the base structure;
ii) mixing a portion of a second ultra-transparent liquid resin to the at least one ultra-transparent liquid resin;
iii) 3D printing a subsequent slice of the base structure; and
iv) iteratively repeating step ii) and iii) until the base structure is formed.

This method may be performed in a single 3D printer, by sequentially pouring in the second ultra-transparent liquid resin into a resin vat such that the ratio of second ultra-transparent liquid resin to the at least one ultra-transparent liquid resin increases sequentially. Alternatively, multiple 3D printers may be used, each of which comprises a resin vat of different resin ratio.

In some embodiments, the difference in refractive index between the 3D printed slices is about 0.001 to about 0.1. In other embodiments, the difference in refractive index is about 0.002 to about 0.1, about 0.004 to about 0.1, about 0.006 to about 0.1, about 0.008 to about 0.1, about 0.01 to about 0.1, about 0.02 to about 0.1, about 0.04 to about 0.1, 0.06 to about 0.1, or about 0.08 to about 0.1.

In some embodiments, the ultra-transparent liquid resin is a UV curable resin. In some embodiments, the ultra-transparent liquid resin is an epoxy based resin. In some embodiments, the ultra-transparent liquid resin is an acrylic based resin. The liquid resin may comprise acrylic monomers, methacrylic monomers, or a combination thereof. When exposed to UV radiation, these monomers quickly form molecular bonds with each other and turn into a solid polymer. In some embodiments, the ultra-transparent liquid resin is NOVA3D ultra-clear resin, Stratasys VeroClear resin, their variants or a combination thereof.

In some embodiments, step a) is performed at an ambient temperature, or preferably at about 20° C. to about 40° C.

In some embodiments, the ultra-transparent liquid resin is characterised by a refractive index of about 1.5 to about 2. In other embodiments, the refractive index is about 1.5 to about 1.9, about 1.5 to about 1.8, about 1.5 to about 1.7, or about 1.5 to about 1.6. For example, NOVA3D ultra-clear resin may be used, which has a refractive index of about 1.53.

In some embodiments, the ultra-transparent liquid resin is characterised by a viscosity of about of about 400 MPa to about 700 MPa, or preferably about 450 MPa to about 600 MPa.

In some embodiments, the ultra-transparent liquid resin is characterised by a volume shrinkage of less than 8%, or preferably less than 1%. In other embodiments, the volume shrinkage is less than 7%, 6%, 5%, 4%, 3% or 2%. For example, NOVA3D ultra-clear resin may be used, which exhibits a volume shrinkage of 3.6% upon curing at 25° C.

In some embodiments, the method further comprises a step before step a) of processing the ultra-transparent liquid resin. This allows the refractive index to be varied.

In some embodiments, the 3D printing is further performed in the presence of a release liner. The release liner may form a film on a surface of the ultra-transparent liquid resin when contained in a liquid vat. The release liner may be perfluoroalkoxy alkanes (PFA).

In some embodiments, the 3D printing is further performed in the presence of a hydrophobic material. The hydrophobic material provides non-stick properties to the 3D printed structure. The hydrophobic material may form a film on top of the release liner. The hydrophobic material may be polytetrafluoroethylene (PTFE).

In some embodiments, the 3D printing is performed in the presence of a light diffuser. The diffuser spreads out light, and makes bright or harsh light softer across a wider area, eliminating unwanted glare. The diffuser may be positioned in a light path between the light source and the LCD screen. Further, a second diffuser may be positioned in a light path between the LCD screen and the 3D printed structure.

In some embodiments, the 3D printing is performed in the presence of a light absorber. The light absorber may be positioned parallel and externally to a light path so as to remove stray light from the light source to the LCD screen.

In some embodiments, the 3D printing is performed using an anti-aliasing function. Antti-aliasing is a computer graphics technique that smoothes jagged edges on curves and diagonal lines. It helps to make digital images appear more realistic by eliminating the “staircase” effect that often appears on curved or angled lines.

The base structure comprises a first surface. The first surface may be in contact with the substrate when 3D printed. In use, the first surface is proximal to a user's eye. The first surface acts to transmit light travelling along a light path in the light guide optical element out of the light guide optical element. In this regard, the light path of the light changes as it is reflected by the semitransparent beam splitter and out of the light guide optical element.

The base structure comprises at least one holding means. The holding means is formed at a second surface, which is opposite the first surface. Each holding means may be used to contain a semitransparent beam splitter. The holding means may be a slope cut into the second surface of the base structure, or may be a slot. In some embodiments, the holding means is a triangular recess.

In some embodiments, the at least one holding means is angled at about 20° to about 40° relative to the first surface, or preferably about 25°. In other embodiments, the angle is about 20° to about 35°, or about 20° to about 30°. The angles for the holding means may all be the same, or may be graduated sequentially to allow for light path compensation in a curved light guide optical element.

Depending on the size of semitransparent beam splitter and eye-box design, multiple semitransparent beam splitters may be used for pupil expansion. In some embodiments, the base structure comprises at least two holding means for contacting at least two semitransparent beam splitters. In some embodiments, the at least one holding means is 3 holding means. In some embodiments, the at least one holding means is 6 holding means.

In some embodiments, the method further comprises a step after step a) of cleaning and further curing the base structure of step a). The base structure may be cleaned in an ultrasonic cleaner with isopropyl alcohol. In some embodiments, alcohol is not used. The base structure may be cured using UV light. These actions may be performed separately or performed together as a single step.

In some embodiments, the base structure is characterised by a refractive index of about 1.5 to about 2. In other embodiments, the refractive index is about 1.5 to about 1.9, about 1.5 to about 1.8, about 1.5 to about 1.7, or about 1.5 to about 1.6. For example, NOVA3D ultra-clear resin may be used.

The semitransparent beam splitter may be placed on the holding means by using a pick-and-place machine or by a fixture set moulding according to the base structure. In this sense, the semitransparent beam splitter is inserted into the holding means. The semitransparent beam splitter may be adhered to the holding means and base structure. Alternatively, the semitransparent beam splitter may be deposited via a deposition method or vacuum deposition method such as chemical vapour deposition.

The semitransparent beam splitter may also be 3D printed. The semitransparent beam splitter may be 3D printed using a different material. For example, metal filament, metal powder, metal wire, or a metal infused resin may be used. Techniques that may be used include Metal Filament Fused Deposition Melting (FDM), Laser Powder Bed Fusion (LPBF), Electron Beam Powder Bed Fusion, aka Electron Beam Melting (EBM), Metal Binder Jetting, Wire Arc Additive Manufacturing (WAAM), Laser Directed Energy Deposition (Laser DED), Electron Beam Directed Energy Deposition (eBeam DED), Micro Metal 3D Printing, Cold Spray, and Molten Direct Energy Deposition.

In some embodiments, the at least one semitransparent beam splitter is selected from a dielectric reflector, metal reflector or a combination thereof. The at least one semitransparent beam splitter may have a flat morphology, or a curved morphology. The curved morphology may follow a gradient of a light path in order to direct light to a user.

The semitransparent beam splitter may be a dielectric reflector. The dielectric reflector may be a mirror composed of a single thin layer or multiple thin layers of dielectric material, typically deposited on a substrate of glass or some other optical material. By careful choice of the type and thickness of the dielectric layers, one can design an optical coating with specified reflectivity at different wavelengths of light. Light which is not reflected is transmitted through the dielectric reflector. The percentage of the reflected light and transmitted light may be controlled by, for example, the thickness and number of the thin layer.

In some embodiments, the at least one semitransparent beam splitter is characterised by a transparency of at least about 85%, or preferably at least about 90%.

In some embodiments, the at least one semitransparent beam splitter is characterised by a transmittance of at least about 85%, or preferably at least about 90%. Transmittance is the fraction of incident light which is transmitted. In other words, it's the amount of light that “successfully” passes through the substance and comes out the other side.

In some embodiments, the at least one semitransparent beam splitter is characterised by a reflection ratio of about 8% to about 20%, or preferably about 10%.

In some embodiments, the semitransparent beam splitter is characterised by root mean square (RMS) roughness of about 1.1 nm to about 1.8 nm. In other embodiments, the RMS roughness is about 1.1 nm to about 1.7 nm, about 1.1 nm to about 1.6 nm, about 1.1 nm to about 1.5 nm, or about 1.1 nm to about 1.4 nm.

In some embodiments, the semitransparent beam splitter is characterised by mean roughness of about 1 nm to about 1.5 nm. In other embodiments, the mean roughness is about 1 nm to about 1.4 nm, about 1 nm to about 1.3 nm, about 1 nm to about 1.2 nm, or about 1 nm to about 1.1 nm.

The light guide optical element may be formed from the base structure in several ways. The base structure with the semitransparent beam splitter may be contacted with additional ultra-transparent liquid resin such that it covers the semitransparent beam splitter. The ultra-transparent liquid resin may then be cured to fully encapsulate the semitransparent beam splitter. For example, the contacting and curing step may be performed as a single step or in a layer-by-layer manner using a micro-assembly machine.

For example, the ultra-transparent liquid resin may be sufficiently added such that it floods the at least one slope. The ultra-transparent liquid resin may be added such that the semitransparent beam splitter is completely immersed. When cured, the second surface of the base structure is formed as a flat surface of the light guide optical element. This surface allows light to pass through the light guide optical element, such that a user can see through the light guide optical element to visualise real images.

Accordingly, in some embodiments, the at least one ultra-transparent liquid resin in step c) is from a different stock solution. In other words, the at least one ultra-transparent liquid resin of step c) is not 3D printed on top of the second surface. The at least one ultra-transparent liquid resin may be poured on the second surface. By altering the type of at least one ultra-transparent liquid resin, the refractive index of the light guide optical element may be tuned.

Alternatively, in some embodiments, the method further comprises a step after step a) of immersing the 3D printed base structure in a tank comprising ultra-transparent liquid resin. The at least one semitransparent beam splitter may be contacted to the at least one holding means in the tank.

In some embodiments, the method further comprises immersing the semitransparent beam splitter in the tank comprising ultra-transparent liquid resin. The semitransparent beam splitter may contact the base structure in the tank comprising ultra-transparent liquid resin. This effectively preventing bubble generation during the placement. This also allows the resin to act as an adhesive for the semitransparent beam splitter to the base structure when cured.

In some embodiments, step c) comprises contacting the at least one ultra-transparent liquid resin with and/or over the second surface and holding means of the base structure and at least one semitransparent beam splitter and curing the at least one ultra-transparent liquid resin. In this way, the at least one semitransparent beam splitter is adhered to the holding means.

In some embodiments, the method further comprises a step of separately 3D printing a top structure. The top structure comprises a third surface adjacent to a printer platform, and a fourth surface opposite the third surface. The fourth surface may have a complementary morphology relative to second surface of the base structure and the at least one semitransparent beam splitter. The top structure may be 3D printed on a separate substrate. The top structure may then be mated to the second surface of the base structure and the at least one semitransparent beam splitter to form the light guide optical element. For example, the at least one semitransparent beam splitter may be contacted with the holding means of the second surface of the base structure, and the top structure may be contacted to the at least one semitransparent beam splitter and second surface in the tank comprising ultra-transparent liquid resin. This assembly may then be cured to form the light guide optical element. This effectively preventing bubble generation during the placement.

As a further example, in some embodiments, step c) comprises contacting a transparent substrate and the at least one ultra-transparent liquid resin over the holding means and second surface of the base structure to form a covered recess, and curing the at least one ultra-transparent liquid resin such that the transparent substrate is adhered to the second surface. The transparent substrate may be a glass substrate. In this regard, the at least one ultra-transparent liquid resin acts as a glue. The covered recess may then be filled with a transparent liquid to form the light guide optical element. The covered recess is thus void of air.

In some embodiments, the transparent liquid is characterised by a refractive index of about 1.4 to about 1.8. In other embodiments, the refractive index is about 1.4 to about 1.7, about 1.4 to about 1.6, or about 1.4 to about 1.5.

In some embodiments, the transparent liquid is silicone oil, mineral oil, polydimethylsiloxane (PDMS), or a combination thereof.

In some embodiments, step c) further comprises applying a pressure to the at least one semitransparent beam splitter during curing such that it homogenously contacts the holding means and/or the second surface. For example, a pressure may be applied between the base structure and the top structure. For example, a pressure may be applied between the transparent substrate and the base structure.

In some embodiments, the at least one ultra-transparent liquid resin is cured under inert conditions in the presence of UV radiation. The inert condition may be a stream of nitrogen gas. The at least one ultra-transparent liquid resin may be cured in a nitrogen chamber.

Alternatively, in some embodiments, step c) comprises 3D printing the ultra-transparent liquid resin over the at least one semitransparent beam splitter. In some embodiments, step c) comprises depositing and at least partially curing the ultra-transparent liquid resin in a slice-by-slice manner. In this way, any gap or space adjacent to the at least one semitransparent beam splitter may be filled up in a layer-by-layer manner.

In some embodiments, step c) comprises varying a refractive index of the ultra-transparent liquid resin such that at least one 3D printed slice has a different refractive index relative to an adjacent 3D printed slice.

In some embodiments, the method further comprises a step of thermally treating the light guide optical element. The thermal treatment may be subjecting the light guide optical element to about 40° C. to about 80° C. for about 20 min to about 60 min. This helps to relieve the internal stress of the light guide optical element that accumulated during the curing phase. In some embodiments, the temperature is about 40° C. to about 70° C., about 40° C. to about 60° C., or about 40° C. to about 50° C. In some embodiments, the duration is about 20 min to about 50 min, about 20 min to about 40 min, or about 20 min to about 30 min.

In some embodiments, the method further comprises a step of removing the substrate from the light guide optical element. For example, the substrate may be a glass, which may be separated from the light guide optical element using a sharp blade.

In some embodiments, the base structure further comprises a prism structure at an end thereof. The prism structure facilitates efficient coupling of light into the waveguide. The prism may be 3D printed together with the base structure. The prism may be a triangular prism. The prism may be placed at an angle of about 40° to about 60° relative to the first surface of the base structure and correspondingly the light guide optical element. This angle ensures total internal reflection within the light guide optical element, enabling optimal light transmission along its path. In some embodiments, the angle is 50°.

In some embodiments, the method further comprises a step after step c) of cleaning the light guide optical element.

Some amount of post-printing curing may be needed to achieve optimal durability for prints made with resin. This may be done via a special UV chamber or simply by exposing the finished print to sunlight. In some embodiments, the method further comprises a step after step c) of further curing the light guide optical element.

In some embodiments, the method further comprises varying a refractive index of the light guide optical element such that at least one 3D printed slice of the light guide optical element has a different refractive index relative to an adjacent 3D printed slice.

In some embodiments, the method further comprises thermal annealing the light guide optical element in order to vary a refractive index of the light guide optical element. By controlling the temperature and duration of the annealing process, a gradient in refractive index can be created.

In some embodiments, the method further comprises rapidly cooling the light guide optical element.

Once formed, the surfaces of the LOE may be polished or laminated with the same material or a different optical material to ensure smoothness and clarity. In some embodiments, the method further comprises a step after step c) of polishing the surfaces of the light guide optical element.

In some embodiments, the light guide optical element is characterised by a transparency of more than about 85%.

In some embodiments, the light guide optical element is characterised by a transmittance of at least about 85% from 420 nm to 700 nm, or preferably at least about 90%.

In some embodiments, the light guide optical element is characterised by a length of about 20 mm to about 50 mm. In some embodiments, the light guide optical element is characterised by a length of about 20 mm to about 45 mm, about 20 mm to about 40 mm, about 25 mm to about 40 mm, or about 30 mm to about 40 mm.

In some embodiments, the light guide optical element is characterised by a width of about 20 mm to about 50 mm. In some embodiments, the light guide optical element is characterised by a width of about 20 mm to about 45 mm, about 20 mm to about 40 mm, about 20 mm to about 35 mm, or about 20 mm to about 30 mm.

In some embodiments, the light guide optical element is characterised by a thickness of about 2 mm to about 15 mm. In some embodiments, the light guide optical element is characterised by a thickness of about 2 mm to about 10 mm, or about 2 mm to about 5 mm. In some embodiments, the light guide optical element is characterised by a thickness of about 3 mm or about 7.5 mm.

The present disclosure also provides a 3D printed light guide optical element formed by the method as disclosed herein. In this regard, the portion of the resin which is 3D printed and the portion of the resin which is filled in the recess of the base structure (not 3D printed) may have the same refractive index if the same resin material is used.

The present disclosure also provides 3D printed light guide optical element, comprising:
a) an ultra-transparent body having a first surface; and
b) at least one semitransparent beam splitter within the ultra-transparent body and angled relative to the first surface;
wherein the 3D printed light guide optical element is characterised by at least one 3D printed slice having a different refractive index relative to an adjacent 3D printed slice.

The present disclosure also provides 3D printed light guide optical element, comprising:
a) an ultra-transparent body having a first surface; and
b) at least one semitransparent beam splitter within the ultra-transparent body and angled relative to the first surface;
wherein a cross section of the 3D printed light guide optical element is characterised by a portion of the cross section having a different refractive index relative to another portion.

In some embodiments, the 3D printed light guide optical element further comprises a projector.

In some embodiments, the 3D printed light guide optical element further comprises a lens. The lens may be adjacent to the prism. The lens may have a focal length of about 20 mm to about 50 mm, about 20 mm to about 45 mm, about 20 mm to about 40 mm, about 20 mm to about 35 mm, about 20 mm to about 30 mm, or about 20 mm to about 25 mm.

In some embodiments, the 3D printed light guide optical element is characterised by a magnification ratio of about 1.1 to about 1.8. In some embodiments, the magnification ratio is about 1.1 to about 1.7, about 1.2 to about 1.7, about 1.3 to about 1.7, or about 1.4 to about 1.7. In some embodiments, the magnification ratio is about 1.4.

In some embodiments, the 3D printed light guide optical element is characterised by root mean square (RMS) surface roughness of about 1.1 nm to about 1.8 nm. In other embodiments, the RMS roughness is about 1.1 nm to about 1.7 nm, about 1.1 nm to about 1.6 nm, about 1.1 nm to about 1.5 nm, or about 1.1 nm to about 1.4 nm.

In some embodiments, the 3D printed light guide optical element is characterised by mean surface roughness of about 1 nm to about 1.5 nm. In other embodiments, the mean roughness is about 1 nm to about 1.4 nm, about 1 nm to about 1.3 nm, about 1 nm to about 1.2 nm, or about 1 nm to about 1.1 nm. In other embodiments, the mean roughness is about 1.1 nm to about 1.5 nm, about 1.2 nm to about 1.5 nm, about 1.3 nm to about 1.5 nm, or about 1.4 nm to about 1.5 nm.

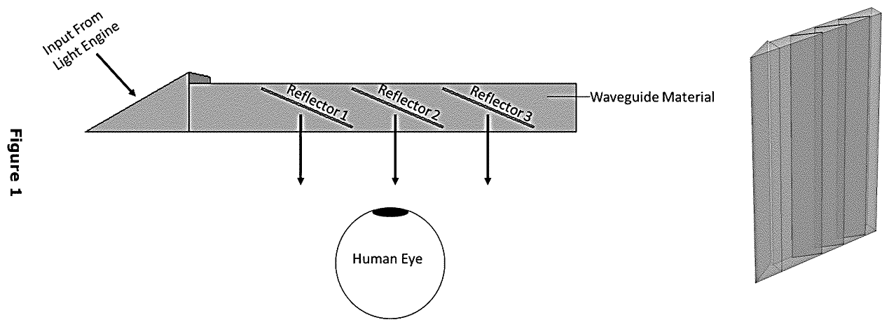

The waveguide or LOE is illustrated in FIG. 1. Light from a source or light engine may be coupled into the waveguide by a prism and directed towards the user's eye through the use of reflectors. FIG. 1 shows a waveguide with three reflectors.

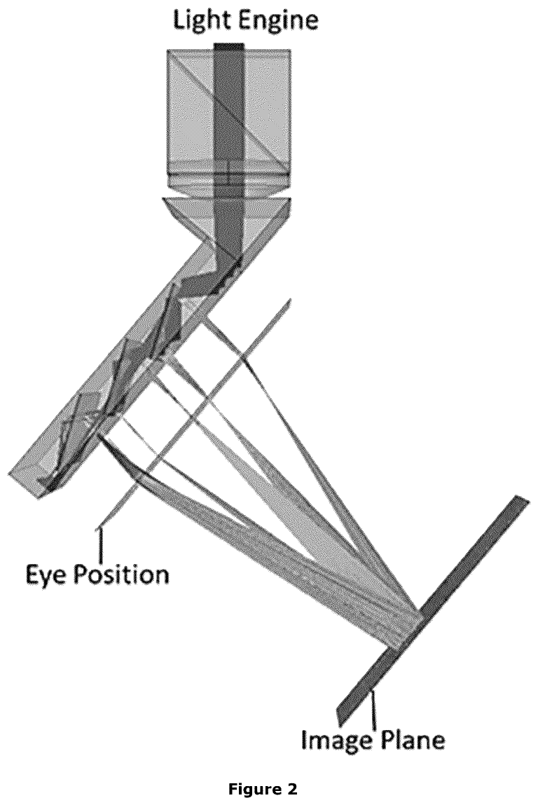

A simulation is performed to demonstrate the efficacy of this waveguide as shown in FIG. 2. FIG. 2 presents the simulated light paths. Due to a combinatory effect of the reflectors and the micro-patterns on the first surface, the resulting image is combined at the retina of the eye.

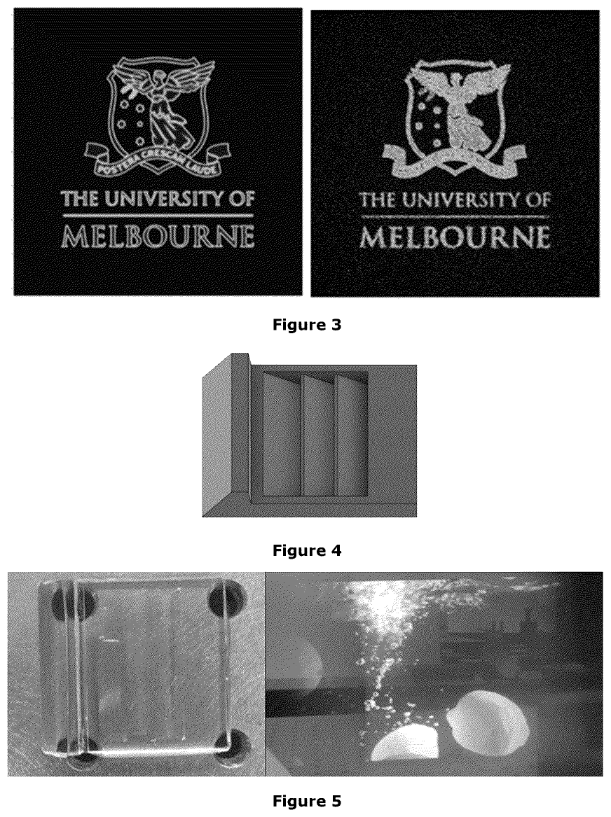

FIG. 3 shows an example of the reconstructed image generated by the waveguide of the present disclosure.

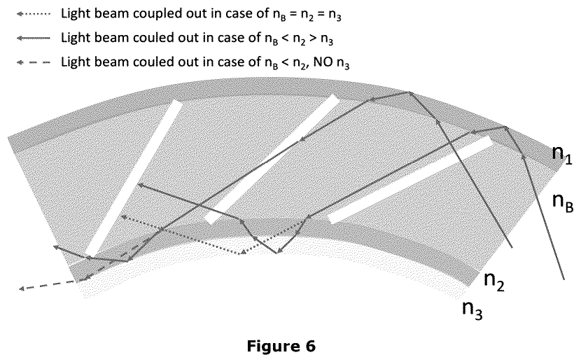

FIG. 5 shows a waveguide prototype and image captured using a camera placed next to the waveguide.

### EXAMPLES

### Simulation Results

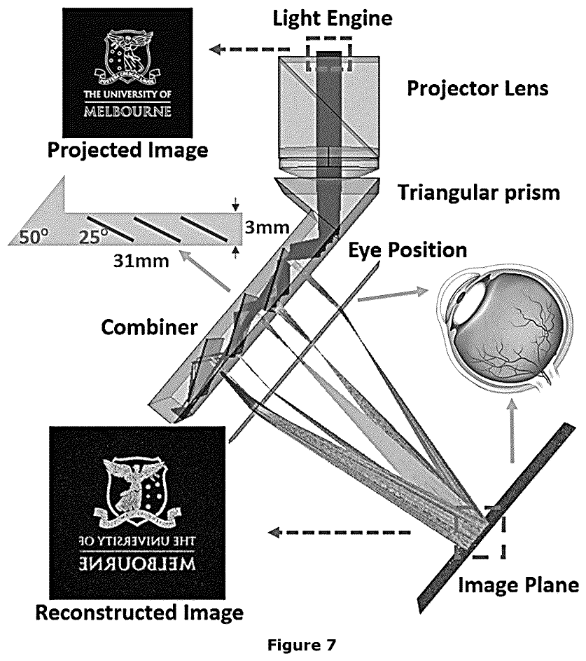

We have optimized our geometric waveguide design using the finite element method implemented in COMSOL Multiphysics to strike a balance between optical performance and fabrication feasibility. For example, if the thickness of the waveguide is too thin, it may result in breakage when removing the printed sample from the glass printing bed. The dimensions of an examplary geometric AR waveguide are 31 mm×26 mm×7.6 mm. A 3D-printed triangular prism is utilized to facilitate the efficient coupling of light into the waveguide. The prism is placed at an angle of 50 degrees relative to the bottom surface of the waveguide. This particular angle ensures total internal reflection within the waveguide, enabling optimal light transmission along its path. For simplicity, the design incorporates three dielectric reflectors, integrated at an angle of 25 degrees relative to the bottom surface, as illustrated in FIGS. 1, 2 and 7. These reflectors serve the purpose of directing the light toward the observer's eye. The projector used in our design is a general LCOS projector with a 40° field of view, which emits a virtual image that is subsequently coupled into the waveguide through the triangular prism. Then, we conducted simulations using COMSOL to evaluate the effectiveness of the design. The simulation parameters included a refractive index of 1.53 for the resin material used in the waveguide. Additionally, considering the propagation loss, the dielectric reflectors employed in the waveguide were assigned a transmittance ratio of 90% based on actual measurements, and wall boundary conditions were applied. Furthermore, we used an ideal lens with a focal length of 25 mm and applied optimal lens boundary conditions to simulate the human eye. FIGS. 2 and 7 shows the simulated ray tracing results, illustrating the propagation of light rays through the waveguide, their convergence at the retina, and the formation of the final image. An example of the computationally reconstructed University of Melbourne's crest is also shown in the figure. To achieve this, an object (bitmap file of the crest) was loaded into the model, where the spatial distribution of rays released from the object's surface was proportional to the bitmap's values. With the release of 23000 rays, we achieved a magnified and perfectly stitched image at the image plane, achieving a magnification ratio of 1.4. This waveguide design not only demonstrates its efficacy in providing high-quality image reconstruction but also takes into consideration its feasibility for fabrication.

### Manufacturing Process—3D Printed Waveguide

The optimized geometric AR waveguide was fabricated using a semi-custom level 3D printer. Our platform is constructed based on the Phrozen Sonic mini 8K resin 3D printer, which is a custom-level liquid-crystal display (LCD) 3D printer. Briefly, a printing bed is immersed in a transparent resin vat and exposed to UV light emitted by an array of LEDs at the bottom. The UV light passes through an LCD screen, acting as a masking element. This reveals the image pattern on the printing bed and selectively cures corresponding pixels. This layering process is repeated for subsequent layers. The LCD screen provides an impressive ultra-high pixel resolution of 22 μm, and the dual linear rails offer a stable z-axis step size of 10 μm.

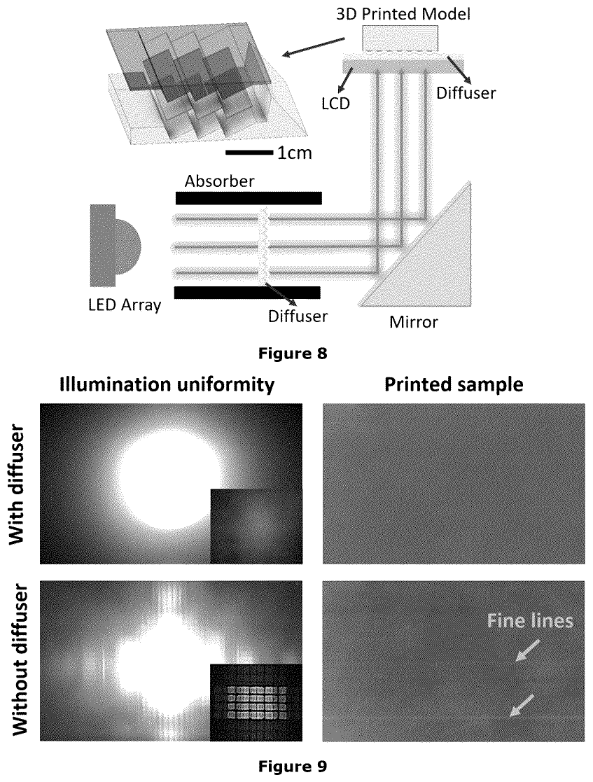

To enhance the uniformity of light distribution, a diffuser and an absorber were placed in front of the light source. Additionally, another diffuser was placed on top of the LCD screen to address the issue of LCD inter-pixel gaps and ensure a seamless display of the image pattern (FIG. 8). In practice, we found that the second diffuser did not significantly impact the x-y plane resolution, particularly when the z-axis step size was under 20 μm. This observation held true, especially for objects lacking intricate details. The resin vat incorporated a thin perfluoroalkoxy (PFA) film as a release liner, aiming for a non-adhesive surface that facilitated the removal of the printed objects upon completion. To enhance non-stick properties, a thin layer of polytetrafluoroethylene (PTFE) was coated on the PFA film. We used NOVA3D ultra-clear resin, which had a relatively stable refractive index of around 1.53 in the visible light wavelength range. At 25° C., it exhibited a volume shrinkage of 3.6% upon curing. Unlike professional inkjet printers, which could achieve smooth surface finishes without additional post-processing, LCD printers could not offer comparable surface finish roughness. A strategy to mitigate this issue was to print the top and bottom waveguide components separately on glass printing beds, followed by integrating them with dielectric reflectors (as seen in FIG. 8). This approach improved the overall surface finish of the waveguide and potentially enhanced its performance. Regarding the prism's sloped surface, achieving a smooth finish is not essential since it could be glued to the projector at a later stage.

We first adhered plain glass slides to the metal printing bed. Using a z-axis step size of 10 μm, the top and bottom components of the waveguide were printed with the flat surface facing down towards the glass slides. To improve the printing quality, antialiasing was implemented on the image pattern during the printing process. This technique effectively blurred the image pattern, reducing the presence of jagged edges and thereby enhancing the subpixel resolution of the final product. The total printing time was around 2 hours, and we did not add any supports to the model. Once the printing process was finished, the printed parts, along with the glass slides, were removed from the printing bed and immersed in a shallow resin tank. The sample was examined under a microscope to assess its quality. Any debris on the surface could be removed by using nitrogen to blow it away gently. It was crucial to avoid using isopropyl alcohol during this cleaning process, as it could potentially diminish the level of transparency. Dielectric reflectors were then carefully placed into the corresponding slots within the resin, effectively preventing bubble generation during the placement. Subsequently, the combined sample was taken out and cured within a nitrogen chamber under UV, with proper pressure applied on the top glass. Then the sample was transferred to a 40° C. hot plate and allowed to undergo a 30-minute thermal treatment to relieve the sample's internal stress that accumulated during the curing phase. Finally, the glass slides were removed using a sharp blade.

### Experimental Results—3D Printed Waveguide

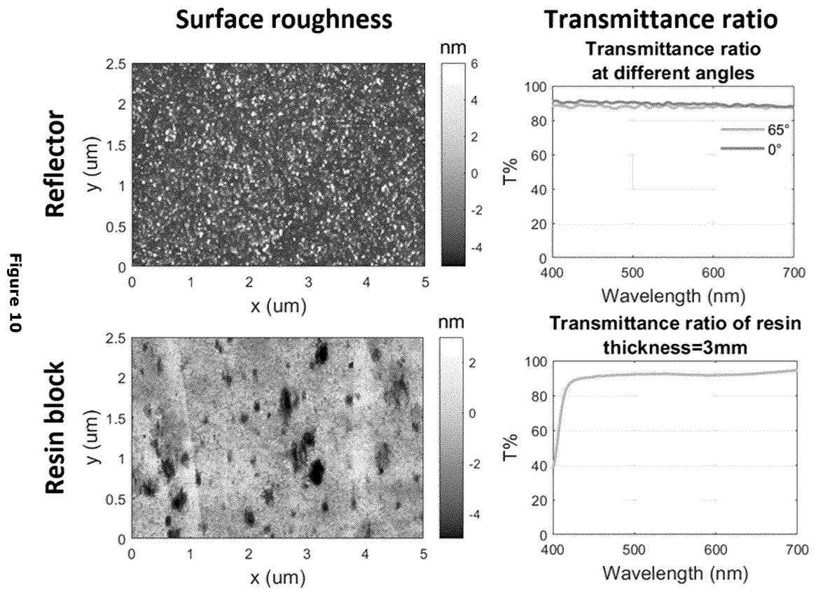

The integration of diffusers led to a significant enhancement in printing quality. The use of the first diffuser, placed in front of the light source, resulted in substantial improvements in light uniformity. The incorporation of the second diffuser on top of the LCD screen further enhanced the uniformity of illumination, effectively mitigating the LCD inter-pixel gaps issue. Without this diffuser, the printed sample displayed many fine lines within its structure (FIG. 9).

In the design, we utilized dielectric thin-film interference filters as reflectors. The surface roughness of the reflector was evaluated using atomic force microscopy (AFM), and the corresponding results are presented in FIG. 10. According to standard surface roughness definitions, the measured RMS roughness of the reflector is Rq=1.40 nm, and the mean roughness is Ra=1.09 nm. In addition to the surface roughness measurements, we assessed the transmittance ratio of the reflector at various angles within the visible light wavelength range. The reflector demonstrates a transmittance ratio of approximately 90% at both 0-degree and 65-degree angles, corresponding to real-world light transmission scenarios (reflector; FIG. 10).

The combined printed waveguide has a thickness of 3 mm. The planar surface printed on the glass slide exhibits good roughness characteristics. It has an RMS roughness of 1.49 nm and a mean roughness of 1.38 nm (resin block; FIG. 10). Regarding the transmittance ratio, the waveguide exhibits low transmittance from 400 nm to 420 nm. However, beyond 420 nm and up to 700 nm, the transmittance ratio consistently remains high, hovering around 90%, which renders it well-suited for a wide range of optical applications within this specific spectral region (FIG. 10).

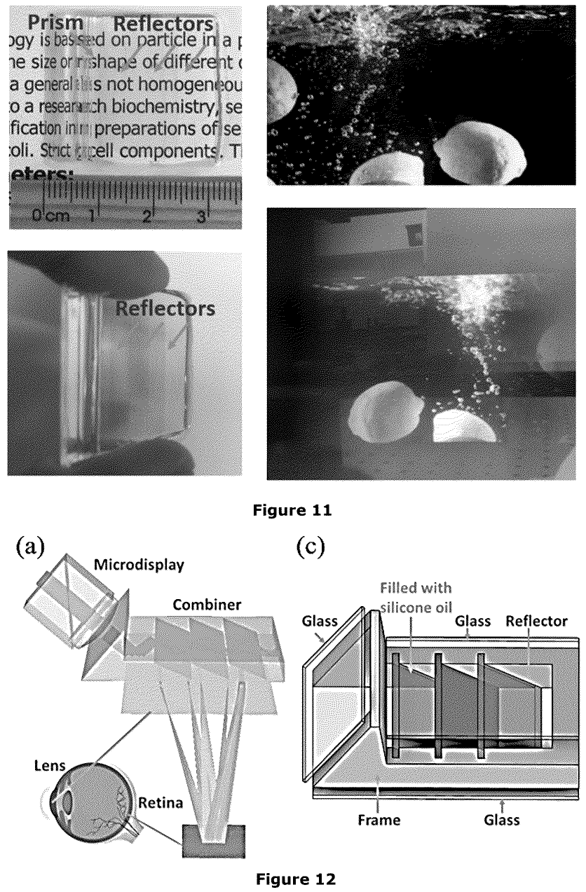

To validate the efficacy of the design, a prototype of the printed AR waveguide, incorporating three dielectric reflectors, was successfully fabricated, as depicted in FIG. 11a-b. Moreover, the AR waveguide was tested using a commercial microprojector. FIG. 11c-d display an example, showing the projected image and the image captured through the waveguide.

### Manufacturing Process and Experimental Results—3D Printed Liquid Waveguide

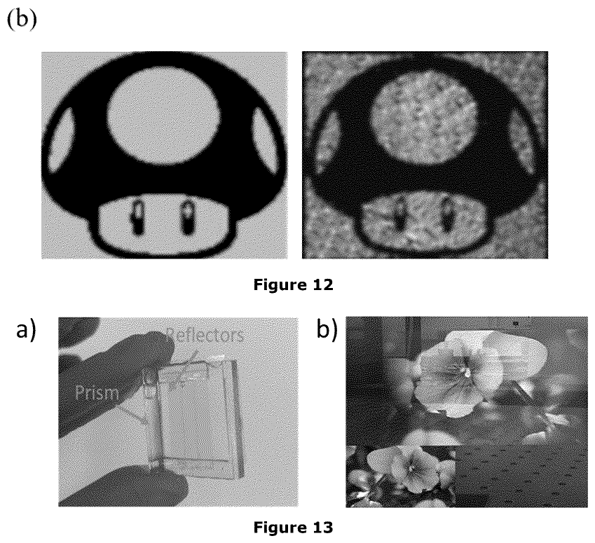

Alternatively, a low-cost liquid reflective optical combiner using silicone oil as the waveguide may be fabricated. FIG. 12c shows the fabrication process. We first 3D printed a waveguide frame using a Stratasys J826 PolyJet 3D printer. The resin we chose was Stratasys VeroClear resin, known for its robust resistance to deformation, showing a flexural strength of at least 75 MPa. For support material, we opted for a water-soluble support using Stratasys SUP707. The frame was printed using high-quality printing mode, resulting in a z-axis step size of 14 μm. The total printing time was around 2 hours. Three dielectric reflectors were then inserted into the slots. Following that, three pieces of thin glass were glued to the frame. Finally, silicone oil was injected into the frame to fill the air gap, and the filling hole was sealed using UV glue. While mineral oil typically has a higher refractive index, which is desirable for waveguide design, we chose silicone oil for its better chemical inertness, superior temperature stability, and lower viscosity. FIGS. 13a and 13b demonstrates a prototype of the liquid optical combiner.

Essentially, the virtual image projected from the microdisplay is coupled into the waveguide through the tri-prism and exits towards the human eye through three reflectors (T=90% based on measurement). The slope of the tri-prism is 50 degrees, and the reflectors are tilted at 25 degrees. The combiner is filled with silicone oil (n=1.41) as the waveguide and protected by thin glasses (n=1.50). The dimensions of the active region of the combiner are 30 mm×26 mm×3.2 mm. FIG. 12b presents an example of the COMSOL simulation results, demonstrating the reconstructed mushroom image on the retina using the suggested combiner design.

Next, we evaluated the optical performance of the combiner using a commercial LCOS microdisplay. FIG. 13b demonstrates an example of the virtual image captured through the waveguide that overlaps with the laboratory environment. The total cost of the prototype is around $18. However, the cost can be further reduced during mass production. Furthermore, the sample can be assembled using an automated assembly machine, such as the one from Ficontech. This eliminates the need for dicing, bonding, and polishing required by traditional manufacturing methods.

### CONCLUSIONS

Herein, we present an approach for the fabrication of geometric AR optical combiners intended for applications in augmented reality. Instead of depending on high-cost inkjet 3D printers, renowned for their exceptional surface smoothness, we have developed a strategy focused on utilizing a cost-effective LCD 3D printer. This printer is custom-adapted to achieve significantly improved surface roughness without the need for molding, dicing, and post-polishing. On the other hand, the inkjet printer requires resin with an extremely low viscosity, which limits the choice of available photoinitiators, stabilizers, and UV absorbers. This constraint, in turn, can raise concerns about resin yellowing. In contrast, the LCD printer offers a broader range of options for resin selection. In the current design, we have integrated only three dielectric reflectors for simplicity. However, additional reflectors can be integrated to expand the eyebox and field of view. Finally, we have successfully fabricated a prototype of the proposed optical combiner, creating a virtual image that seamlessly overlaps with the real world. This achievement demonstrates the system's potential for low-cost mass production.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1.-43. (canceled)

44. A method of 3D printing a light guide optical element, comprising:
a) 3D printing a base structure using at least one ultra-transparent liquid resin, the base structure comprising a first surface and at least one holding means formed at a second surface opposite to the first surface and angled relative to the first surface;
b) contacting at least one semitransparent beam splitter to the at least one holding means; and
c) contacting at least one ultra-transparent liquid resin over the at least one semitransparent beam splitter and curing the at least one ultra-transparent liquid resin in order to form the light guide optical element.

45. The method according to claim 44, wherein step a) comprises depositing and at least partially curing the at least one ultra-transparent liquid resin in a slice-by-slice manner.

46. The method according to claim 44, wherein the base structure is 3D printed using liquid crystal display (LCD), stereolithography (SLA), or PolyJet 3D printing.

47. The method according to claim 44, wherein step a) comprises varying a refractive index of the at least one ultra-transparent liquid resin such that at least one 3D printed slice of the base structure has a different refractive index relative to an adjacent 3D printed slice.

48. The method according to claim 47, wherein step a) comprises 3D printing the base structure using a mixture of the at least one ultra-transparent liquid resin and a second ultra-transparent liquid resin having a different refractive index such that at least one 3D printed slice of the base structure has a different refractive index relative to an adjacent 3D printed slice.

49. The method according to claim 44, wherein the difference in refractive index between the 3D printed slices is about 0.001 to about 0.1.

50. The method according to claim 44, wherein the ultra-transparent liquid resin is an acrylic based resin.

51. The method according to claim 44, wherein the at least one holding means is a slope cut into the second surface of the base structure;
wherein the at least one holding means is angled at about 20° to about 40°.

52. The method according to claim 44, wherein the at least one holding means is 3 holding means, and the at least one semitransparent beam splitter is 3 semitransparent beam splitters.

53. The method according to claim 44, wherein the at least one semitransparent beam splitter is selected from a dielectric reflector, metal reflector or a combination thereof; and is characterised by at least one of the following:
a) a transparency of at least 85%;
b) a reflection ratio of about 8% to about 20%; and
c) root mean square (RMS) roughness of about 1.1 nm to about 1.8 nm.

54. The method according to claim 44, wherein step c) comprises immersing the 3D printed base structure in a tank comprising ultra-transparent liquid resin, and immersing the at least one semitransparent beam splitter in the tank such that the at least one semitransparent beam splitter contacts the holding means of the base structure.

55. The method according to claim 44, wherein the method further comprises a step of separately 3D printing a top structure, the top structure comprises a third surface and a fourth surface opposite the third surface, wherein the fourth surface comprises a complementary morphology relative to second surface of the base structure and the at least one semitransparent beam splitter, and mating the base structure and the at least one semitransparent beam splitter with the top structure to form the light guide optical element.

56. The method according to claim 44, wherein step c) comprises contacting a transparent substrate and the at least one ultra-transparent liquid resin over the holding means and the second surface of the base structure to form a covered recess, curing the at least one ultra-transparent liquid resin such that the transparent substrate is adhered to the second surface, and filling the covered recess with a transparent liquid to form the light guide optical element;
wherein the transparent liquid is characterised by a refractive index of about 1.4 to about 1.8.

57. The method according to claim 56, wherein the transparent liquid is silicone oil, mineral oil, polydimethylsiloxane (PDMS), or a combination thereof.

58. The method according to claim 44, wherein step c) comprises 3D printing the ultra-transparent liquid resin over the at least one semitransparent beam splitter.

59. The method according to claim 58, wherein step c) comprises varying a refractive index of the ultra-transparent liquid resin such that at least one 3D printed slice has a different refractive index relative to an adjacent 3D printed slice.

60. The method according to claim 44, wherein the base structure further comprises a prism structure at an end thereof;
wherein the prism is a triangular prism positioned at an angle of about 40° to about 60° relative to the first surface of the base structure.

61. The method according to claim 44, wherein the method further comprises a step after step a) of cleaning and further curing the base structure of step a).

62. The method according to claim 44, wherein the method further comprises thermal annealing the light guide optical element.

63. A 3D printed light guide optical element, comprising:
a) an ultra-transparent body having a first surface; and
b) at least one semitransparent beam splitter within the ultra-transparent body and angled relative to the first surface;
wherein the 3D printed light guide optical element is characterised by at least one 3D printed slice having a different refractive index relative to an adjacent 3D printed slice; or
wherein a cross section of the 3D printed light guide optical element is characterised by a portion of the cross section having a different refractive index relative to another portion.
